(19) United States
(12) Patent Application Publication
(10) Pub. No.: US 2010/0118016 A1
(43) Pub. Date: May 13, 2010

(54) VIDEO VOLTAGE SUPPLYING CIRCUIT, ELECTRO-OPTICAL APPARATUS AND ELECTRONIC APPARATUS

(75) Inventor: Norio FUJIMURA, Suzaka-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/607,378

(22) Filed: Oct. 28, 2009

(30) Foreign Application Priority Data
Nov. 10, 2008 (JP) 2008-287587

(51) Int. Cl. G09G 5/00

(52) U.S. Cl. 345/211

(57) ABSTRACT

A video voltage supplying circuit includes: a circuit that supplies high and low level voltages to a common electrode through a feed line. When positive polarity enables a pixel electrode in a voltage level higher than the common electrode, the low level common voltage is supplied, and when negative polarity enables the pixel electrode in a voltage level lower than the common electrode, the high level common voltage is supplied. A circuit connected to a video supply line is supplied with high and low level video voltages. When the voltage is applied to the scan line, the circuit supplies the high or low level video voltages to a pixel based upon designation of white display or black display and designation of written polarity. A video voltage supplying circuit generates an offset voltage to supply the video voltage by offsetting the common voltage by a predetermined voltage in a predetermined direction.

### BACKGROUND

1. Technical Field

The present invention relates to a technology for preventing burn-in or flicker.

2. Related Art

In an electro-optical apparatus using liquid crystal, a liquid crystal capacitance, in which the liquid crystal is interposed between a pixel electrode and a common electrode, is disposed at each pixel. The electro-optical apparatus is generally designed in an AC driving manner where voltages applied to the pixel electrodes are alternately changed between a high level (positive polarity) voltage and a low level (negative polarity) voltage with respect to the common electrode. In an active matrix type where the pixel electrodes are driven by a thin film transistor (hereinafter, referred to as “TFT”), a so-called field-through phenomenon (sometimes, referred to as pushdown or penetration) occurs. The field-through phenomenon is a phenomenon that, in the case of an n channel type TFT, at the time of turning off the TFT, the voltage of the pixel electrode (drain electrode) falls irrespective of the written polarity. Therefore, if the polarity reference of the voltage applied to the pixel electrode is equal to that of the common electrode, the effective value of the voltage sustained in the liquid crystal capacitance varies with the positive polarity and the negative polarity, which causes the so-called burn-in or flicker. Therefore, the voltage applied to the common electrode are designed to be different from the voltage of the polarity reference so that the variance in the voltage due to the field-through phenomenon can be compensated for in advance (refer to Patent Document JP-A-11-202366).

However, in a configuration where the voltage of the common electrode is maintained to be constant, since the voltage amplitude of a data signal has a coverage of from the negative polarity to the positive polarity, the data line driving circuit that supplies the data signal to a data line needs to have a voltage resistance to cope with the voltage amplitudes of the component devices, and there is a disadvantage in terms of power consumption. For this reason, well-known is a method of driving the common electrode with two values. That is, when a positive polarity voltage is applied to the pixel electrode, the common electrode is designed to have a low level voltage, and when a negative polarity voltage is applied to the pixel electrode, the common electrode is designed to have a high level voltage.

In a case where the common electrode is driven with the two-valued voltages, in order to compensate for the field-through phenomenon, at least two video voltages, which are obtained to compensate for the change in the voltage due to the field-through phenomenon, are needed for each of the two-valued voltages of the common electrode. That is, a total of at least four voltages are needed.

In this case, in a configuration where the four voltages are separately generated, if the two-valued voltages of the common electrode are changed due to some reason, the effective value of voltage sustained in the liquid crystal capacitance varies with the positive polarity and the negative polarity again.

### SUMMARY

An advantage of some aspects of the invention is to provide a technology for preventing the effective value of voltage sustained in a liquid crystal capacitance from varying with a positive polarity and a negative polarity irrespective of a change in two-valued voltages of a common electrode in a case where the common electrode is driven with the two-valued voltages.

According to an aspect of the invention, there is provided a video voltage supplying circuit in an electro-optical apparatus which includes: a plurality of scan lines; a plurality of data lines; pixels that are disposed corresponding to intersections of the scan lines and the data lines, where each pixel includes a transistor having a gate electrode that is connected to the scan line to be applied with a select voltage, a source electrode that is connected to the data line, and a drain electrode that is connected to a pixel electrode and a liquid crystal capacitance where liquid crystal is interposed between the pixel electrode and a common electrode; a common electrode driving circuit that supplies high and low level common voltages to the common electrode through a common feed line, wherein when positive polarity writing for enabling the pixel electrode to be in a voltage level higher than a voltage of the common electrode is performed on the pixel corresponding to the one scan line, the low level common voltage is supplied, and when negative polarity writing for enabling the pixel electrode to be in a voltage level lower than the voltage of the common electrode is performed on the pixel corresponding to the one scan line, the high level common voltage is supplied; a data line driving circuit that is connected to a video feed line supplied with high and low level video voltages, wherein when the select voltage is applied to the one scan line, the data line driving circuit supplies one of the high and low level video voltages to the pixel corresponding to the one scan line through the data line according to the designation of the white display or the black display and the designation of the written polarity; and a video voltage supplying circuit that is connected to the common feed line to supply the high and low level video voltages to the video feed line based on the high and low level common voltages, wherein the video voltage supplying circuit comprises an offset voltage generating circuit generating an offset voltage to supply as the video voltage a voltage that is obtained by offsetting the common voltage by only a predetermined voltage in a predetermined direction by using the offset voltage.

According to the invention, since the voltage that is obtained by offsetting the common voltages by a predetermined voltage in a predetermined direction is applied as the video voltage, even if the two-valued voltages of the common electrode are changed, the effective value of the voltage sustained in the liquid crystal capacitance does not be vary with the positive polarity and the negative polarity.

In addition, as another configuration of the invention, the video voltage supplying circuit may connect the common feed lines with the video feed lines so that the voltages of the video feed lines are equal to the voltage of the high and low level common voltages, and next, the video voltage supplying circuit may apply the offset voltage output from the offset voltage generating circuit to the video feed lines. According to the configuration, the high and low level video voltages can be easily obtained from the common voltage with by using a relatively simple configuration.

In addition, as another configuration of the invention, the video voltage supplying circuit includes: a first switch that connects the common feed lines to the video feed lines; an offset voltage generating circuit that is connected between the common feed lines that supply the high and low level common voltages, respectively; a second switch that connects the offset voltage output from the offset voltage generating circuit to the low level video feed line; and a capacitance device, wherein two terminals of the capacitance device are connected to the video feed lines that supply the high and low level video voltages, and the output terminal of the offset voltage generating circuit and the one terminal of the capacitance device connected to the video feed line are connected to each other through the second switch, wherein when the first switch is turned on, the first switch connects the two terminals of the capacitance device to the common feed lines so that the voltages of the video feed lines are equal to the high and low level common voltages, respectively, wherein when the first switch is turned off, the second switch is turned on to connect the one terminal of the capacitance device to the output terminal of the offset voltage generating circuit so that the offset voltage is applied to the video feed line, and wherein during the period when the second switch is turned on, the select voltage is applied to the one scan line so that the offset voltage is supplied as the video voltage to the pixel. According to the configuration, the high and low level video voltages can be easily obtained from the common voltage by using a relatively simple configuration.

In addition, in the invention, wherein the transistor, the first switch, and the second switch may be constructed with thin film transistors that are formed on the same glass substrate. According to the configuration, circuits can be integrated on the glass substrate by using a system on glass (SOG) technology.

In addition, the invention can be configured to be an electro-optical apparatus as well as a video voltage supplying circuit. In a case where the invention is configured to be the electro-optical apparatus, the data line driving circuit may select one of the high and low level video voltages to apply the signal to the data line according to a logical exclusive OR signal of the image signal designating a white display or a black display and the polarity designating signal designating written polarity. According to the configuration, the influence of noise can be removed.

In addition, the invention may be configured as an electronic apparatus including the electro-optical apparatus as well as the electro-optical apparatus.

### BRIEF DESCRIPTION OF THE DRAWINGS

The invention will be described with reference to the accompanying drawings, wherein like numbers reference like elements.

FIG. 1 is a view showing an electro-optical apparatus that employs a video voltage supplying circuit according to an embodiment.

FIG. 2 is a view showing a configuration of pixels in the electro-optical apparatus.

FIG. 3 is a view showing the driving operations of scan lines in the electro-optical apparatus.

FIG. 4 is a view showing the driving operations of data lines in the electro-optical apparatus.

FIG. 5 is a view showing the operations of the video voltage supplying circuit in the electro-optical apparatus.

FIGS. 6A and 6B are views showing a field-through phenomenon compensating operation in the electro-optical apparatus.

FIG. 7 is a view showing a configuration of a head-up display that employs the electro-optical apparatus.

FIG. 8 is a view showing a circuit that selects a white voltage or a black voltage.

### DESCRIPTION OF EXEMPLARY EMBODIMENTS

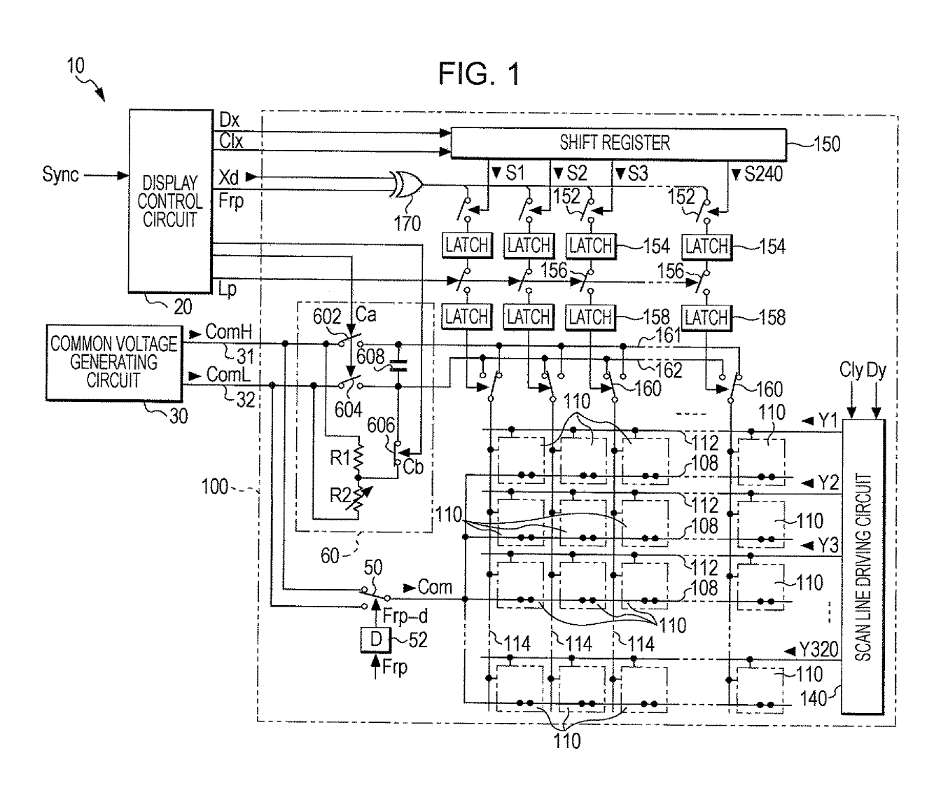

Hereinafter, embodiments for implementing the invention will be described. FIG. 1 is a block diagram showing a configuration of an electro-optical apparatus that employs a video voltage supplying circuit according to an embodiment of the invention.

As shown in the figure, the electro-optical apparatus 10 includes a display control circuit 20, a common voltage generating circuit 30, and a display panel 100. The display control circuit 20 generates various clock signals and control signals so as to control components based on synchronization signals Sync supplied from a higher-level apparatus (not shown).

In addition, an image signal Xd, which defines the display states of pixels in a display panel 100 as well as the synchronization signal Sync, is supplied from the higher-level apparatus. The image signal Xd is digital data that designate each pixel of the display panel 100 with a bright white display or a dark black display. The image signals Xd are supplied in the order of pixels scanned according to a vertical scan signal (not shown), a horizontal scan signal (not shown), and a dot clock signal (not shown) of the synchronization signal Sync. For the convenience of description, when the image signal Xd is in the H level, the pixel is designated with a white display, and when the image signal Xd is in the L level, the pixel is designated with a black display.

The common voltage generating circuit 30 generates two common voltages applied to the common electrode in the display panel 100, that is, a high level voltage ComH and a voltage ComL lower than the voltage ComH and outputs the voltage ComH and the voltage ComL to the common feed line 31 and the common feed line 32, respectively.

The display panel 100 is constructed in a peripheral circuit embedded type where various circuits are disposed at the vicinity of an area in which the pixels 110 are arrayed.

In the embodiment, 320 rows of scan lines 112 are extended in the transverse (row) direction in the figure, and 240 columns of data lines 114 are extended in the longitudinal (column) direction. In addition, in FIG. 1, the pixels 110 are arrayed in correspondence with the intersections of the first to 320-th row scan lines 112 and the first to 240-th column data lines 114. Therefore, in the embodiment, the pixels 110 are arrayed in a matrix of (longitudinal 320 rows)×(transverse 240 columns), but the invention is not limited to the array.

The scan line driving circuit 140 outputs scan signals according to a start pulse Dy and a clock signal Cly supplied from the display control circuit 20. More specifically, as shown in FIG. 3, the scan line driving circuit 140 sequentially shifts the start pulse Dy defining the start of the frame according to the clock signal Cly synchronized with the horizontal scan signal and shortens a pulse width thereof so as to be less than one half of frequency of the clock signal. Cly, so that the scan signals Y1, Y2, Y3, Y4, Y320 are output. Therefore, the scan lines 112 are selected in the order of first, second, third, . . . , and 320-th rows that are counted from the upside of the figure. In addition, the scan signal to the selected scan line is a select voltage VH corresponding to the H level, and the scan signals to the other scan lines are non-select voltages VL corresponding to the L level.

Herein, the frame (period) is a period required to display one coma amount of an image by driving the display panel 100. If a vertical scan frequency is 60 Hz, the frame is 16.7 ms, which is the reciprocal number of the frequency. In the embodiment, as shown in FIG. 3, the frame period includes an effective vertical scan period Fa that is a the time interval from the time when the scan signal Y1 is in the H level to the time when the scan signal Y320 is in the L level and other vertical flyback time intervals.

In addition, in the embodiment, one half of a frequency, in which a logic level of the clock signal Cly is constant, is defined as a horizontal scan period H.

For the convenience of description, a polarity designating signal Frp, among the control signals output from the display control circuit 20, is described.

The polarity designating signal Frp is a signal that is output from the display control circuit 20 to designate a written polarity to the pixel 110. For example, if the logic level thereof is the L level, the polarity designating signal Frp designates positive polarity writing. If the logic level thereof is the H level, the polarity designating signal Frp designates negative polarity writing. In the embodiment, as shown in FIG. 3, since the logic level of the polarity designating signal Frp is changed every horizontal scan period, the written polarity is inverted every row in the frame period, which is called a scan line inversion type.

In addition, comparing the polarity designating signals Frp in the same horizontal scan periods between neighboring frame periods, the polarity designating signals has a relationship of logical inversion. The logical inversion is provided so as to prevent the deterioration of the liquid crystal caused by the application of DC component.

In addition, in the written polarity according to the embodiment, when the voltage is sustained in the liquid crystal capacitance 120, the case where the voltage of the pixel electrode 118 is higher than the voltage of the common electrode 108 is set to the positive polarity, and the case where the voltage of the pixel electrode 118 is lower than the voltage of the common electrode 108 is set to the negative polarity. In terms of the voltage, if there no specific limitation, a ground voltage (not shown) is taken as a reference of voltage zero.

The delay circuit 52 delays the polarity designating signal Frp by the horizontal scan period H and outputs a signal Frp-d.

When the signal Frp-d is in the L level, a double-throw switch 50 selects the common feed line 31. When the signal Frp-d is in the H level, the double-throw switch 50 selects the common feed line 32. As a result, the voltages applied to the selected common feed lines are output to the common electrode 108 as the common signals Com. Therefore, the switch 50 can serve as a common electrode driving circuit that drives the common electrode 108.

In addition, as shown in FIG. 3, in the case where the polarity designating signal Frp is in the L level so that the positive polarity writing is designated, the common signal Com is delayed by the horizontal scan period H to have the voltage ComL, and in a case where the polarity designating signal Frp is in the H level so that the negative polarity writing is designated, the common signal Com is delayed by the horizontal scan period H to have the voltage ComH.

In the horizontal scan period H, there is a shift between the timing when the logical exclusive OR of the image signal Xd and the polarity designating signal Frp is calculated and the timing when the voltage according to the logical exclusive OR is supplied to the data line 114 as the data signal. For this reason, the configuration where the voltage of the common signal Com is changed according to the signal obtained by delaying the polarity designating signal Frp by the horizontal scan period H is provided to acquire matching between the two timings.

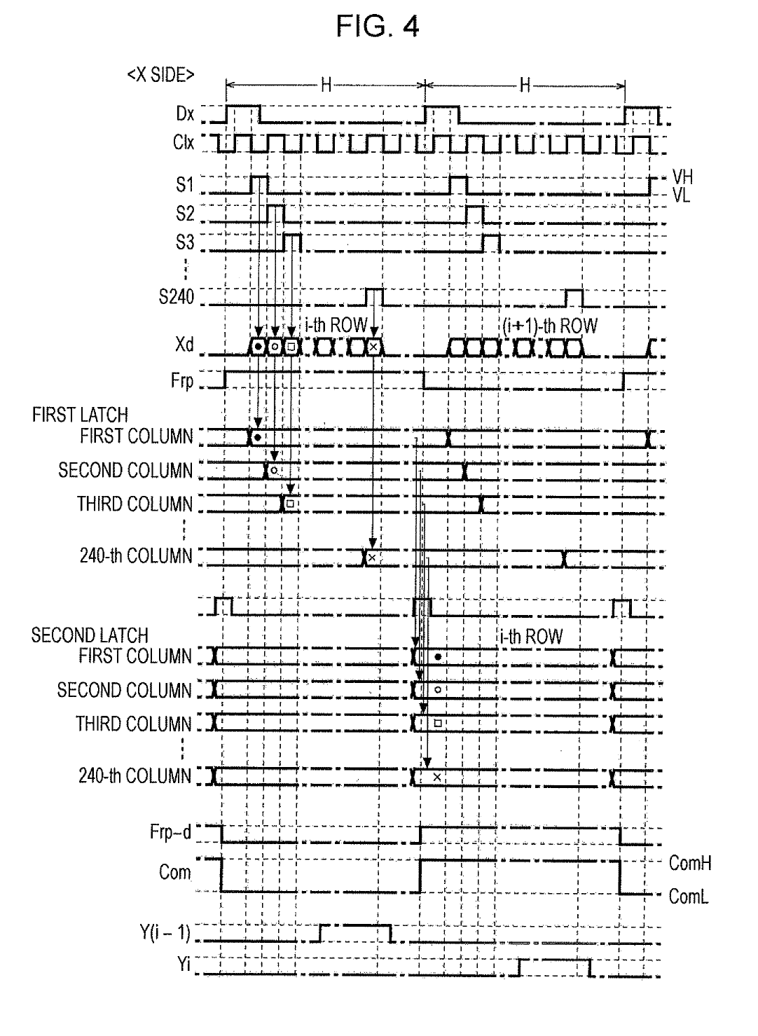

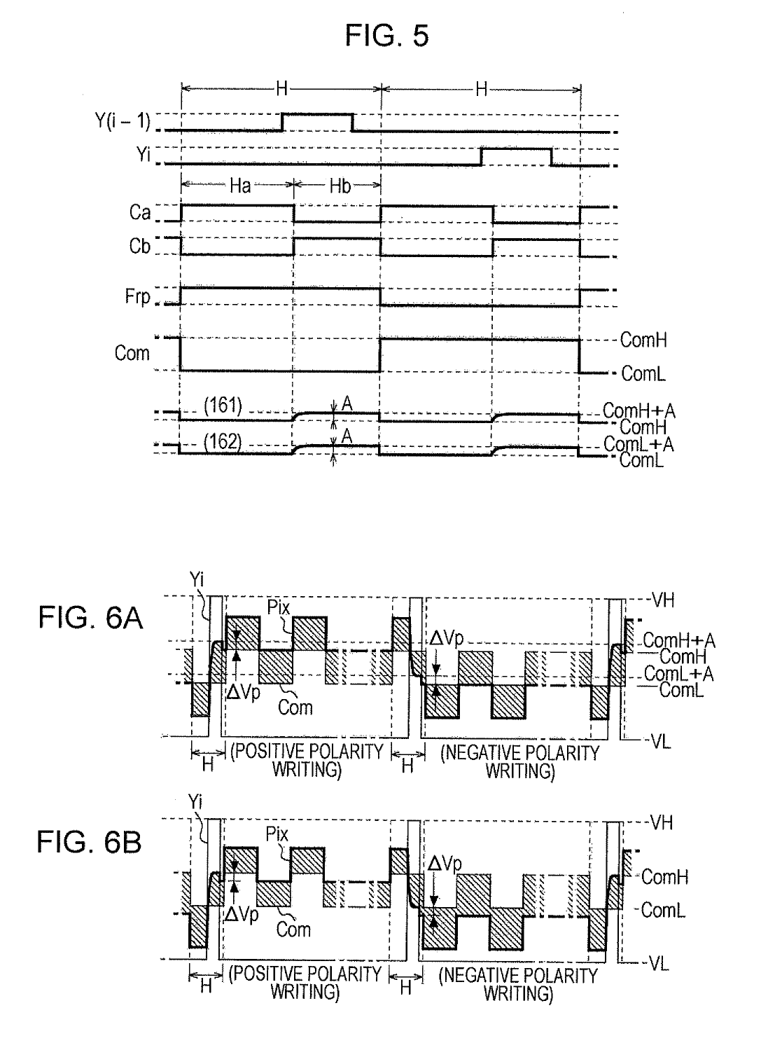

In addition, in FIG. 3, the voltage scale of the common signal Com is wider than the voltage scale of the other logic signals (the same configuration is used in FIGS. 4 and 5).

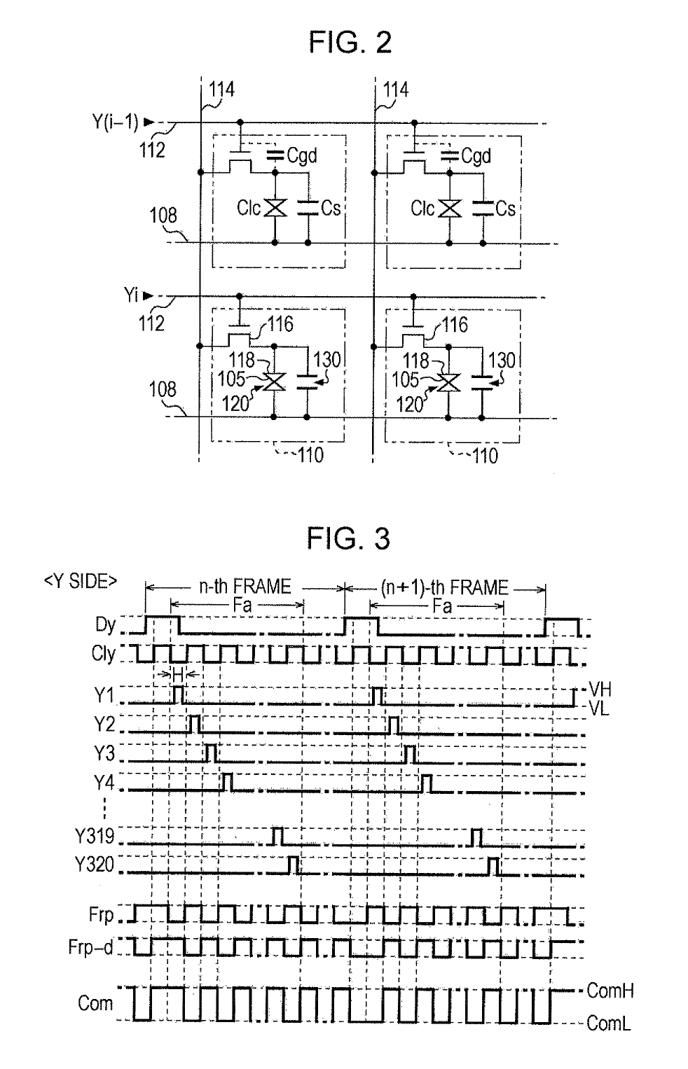

Next, for the convenience of description, a configuration of the pixel 110 is described in detail. FIG. 2 is a view showing a configuration of the pixel 110. More specifically, FIG. 2 shows the configuration of 2×2 (=4) pixels corresponding to intersections of an i-th row and an (i−1)-th row that is adjacent thereto in the upward direction and a j-th column and a (j−1)-th column that is adjacent thereto in the leftward direction.

Herein, (i−1) and i are integers of 1 to 320 for generalizing and describing the row numbers of the scan lines, and (j−1) and j are integers of 1 to 240 for generalizing and describing the column numbers of the data lines.

As shown in FIG. 2, each pixel 110 includes an n channel type TFT 116, a liquid crystal capacitance 120, and an auxiliary capacitance 130. Since all the pixels 110 have the same configuration, the pixel disposed at the i-th row and the j-th column is representatively described. In the TFT 116 of the pixel 110 of the i-th row and the j-th column, the gate electrode thereof is connected to the i-th row scan line 112, the source electrode thereof is connected to the j-th column data line 114, and the drain electrode thereof is connected to the pixel electrode 118 that is the one terminal of the liquid crystal capacitance 120 and one terminal of the auxiliary capacitance 130.

The other terminal of the liquid crystal capacitance 120 and the other terminal of the auxiliary capacitance 130 are commonly connected to the common electrode 108 for all the pixels 110. In addition, in FIG. 2, Y (i−1) and Yi denote scan signals that are applied to the (i−1)-th and i-th row scan lines 112, respectively.

The display panel 100 has a configuration where a pair of substrates, that is, a device substrate made of glass in which the pixel electrodes 118 are formed and an opposite substrate in which the common electrode 108 is formed, are attached to each other with a predetermined gap (interval) therebetween so that electrode forming surfaces face each other and liquid crystal 105 is sealed in the gap. Therefore, the liquid crystal capacitance 120 is formed by interposing the liquid crystal 105 that is a kind of a dielectric material between the pixel electrode 118 and the common electrode 108 to sustain a voltage difference between the pixel electrode 118 and the common electrode 108. In the configuration, in the liquid crystal capacitance 120, an amount of the transmitting light is changed according to an effective value of the sustain voltage. However, in the embodiment, two-valued display is performed for any one of bright white display and dark black display. In addition, in the embodiment, for the convenience of description, normally-white mode is used wherein the transmittance is maximized at the time when the effective value of the voltage sustained in the liquid crystal capacitance 120 is zero.

In the configuration, if the scan line 112 is selected to have the select voltage, the TFT 116 is turned on, so that the pixel electrode 118 is connected to the data line 114. In addition, if the selection of the scan line 112 is ended to have the non-select voltage, the TFT 116 is turned off, so that pixel electrode 118 is disconnected from the data line 114. However, due to the parallel capacitance of the liquid crystal capacitance 120 and the auxiliary capacitance 130, the voltage applied to the pixel electrode 118 at the time when the TFT 116 is turned on is sustained.

Therefore, when the scan line 112 has the select voltage, if the video voltage applied to the data line 114 is set to a voltage substantially equal to the voltage of the common electrode 108, the voltage sustained in the liquid crystal capacitance 120 becomes substantially zero so that a white display with a high transmittance is obtained. On the other hand, if the video voltage is set to a voltage greatly different from the voltage of the common electrode 108, the voltage sustained in the liquid crystal capacitance 120 is increased so that a black display with a small transmittance is obtained.

In an actual TFT 116, as shown by a dotted line in FIG. 2, a parasite capacitance Cgd exists between the gate electrode and the drain electrode.

Therefore, electric charges charged in the liquid crystal capacitance 120, the auxiliary capacitance 130, and the parasite capacitance at the time when the scan line 112 has the select voltage so that the TFT 116 is turned on are re-distributed among the capacitances at the time when the scan line 112 has the non-select voltage so that the TFT 116 is turned off, the voltage of the pixel electrode 118 (drain electrode) falls by a voltage ΔVp (in case of an n channel type TFT 116). More specifically, if the capacitances of the liquid crystal capacitance 120 and the auxiliary capacitance 130 are denoted by Clc and Cs, respectively, the fall in the voltage ΔVp can be expressed by the following equation.

ΔVp=(VH−VL)·Cgd/(Cgd+Clc+Cs)

Basically, the voltage writing for the liquid crystal capacitance 120 is performed in a manner where the pixel electrode 118 is alternately driven by the positive polarity and the negative polarity of the common electrode 108. However, the voltage ΔVp has a change in the direction of the fall for any one of the written polarities.

In the AC driving, if the video voltage applied to the data line oscillates in the positive and negative directions with respect to the voltage of the common electrode used as a reference voltage, due to the fall in the voltage due to the field-through phenomenon, the effective value of the voltage of the liquid crystal capacitance 120 in the negative polarity writing is slightly larger than that in the positive polarity writing, so that a DC component is applied. As a result, deterioration in image quality such as so-called burn-in or flicker occurs.

Therefore, the reference of the video voltage is not set to the voltage of the common electrode, but it needs to be set to a voltage that is obtained by offsetting the high level common voltage in advance by the fall in the voltage due to the field-through phenomenon. Particularly, in a driving method where the voltage of the common electrode oscillates between the low level common voltage and the high level common voltage, two references of the video voltage need to be prepared for the times when the positive polarity writing is designated and the times when the negative polarity writing is designated.

However, in the embodiment, the two-valued display, that is, a white or black display, is performed on the pixel, and the normally-white mode is used in the explanation, the reference video voltage at the time when the positive polarity writing is designated can be used as the video voltage at the time when the positive polarity writing is designated and white display is designated to the pixel, and can also be used as the video voltage at the time when the negative polarity writing is designated and black display is designated to the pixel. On the other hand, the reference video voltage at the time when the negative polarity writing is designated can be used as the video voltage at the time when the positive polarity writing is designated and black display is designated to the pixel, and can also be used as the video voltage at the time when the negative polarity writing is designated and white display is designated to the pixel. Therefore, in the embodiment, the video voltages can be sufficiently implemented by the two-valued voltages, that is, the high and low level voltages.

It should be noted that, in a configuration where the two-valued voltages for the video voltages are generated independently of the two-valued voltages for the common voltages, that is, the high and low level voltages, the following problem may occur. Firstly, when the two-valued voltages for the common voltage are changed due to some reason, an AC component may be applied to the liquid crystal capacitance. Secondly, as viewed in terms of the voltage feed lines, the number of points of connection to the display panel 100 becomes four.

Therefore, in the embodiment, the display panel 100 is provided with a video voltage supplying circuit 60 that generates the two-valued voltages for the video voltages from the two-valued voltages for the common voltages, so that only the two-valued voltages for the common voltages can be applied to the display panel 100 and the change in the two-valued voltages for the common voltages can be reflected in the two-valued voltages for the video voltages. The video voltage supplying circuit 60 may be formed on the same glass substrate as the display panel 100 on which the TFTs 116 constituting the pixels 110 are formed, by using a system on glass (SOG) technology in which circuits are integrated on a glass substrate by using a low temperature polysilicon technology. Accordingly, the number of semiconductor devices can be reduced, assembling can be simplified, and the size of an external circuit board can be reduced, so that a small size, a light weight, and a low cost can be implemented in terms of the whole configuration.

The video voltage supplying circuit 60 is described with reference to FIG. 1.

In the video voltage supplying circuit 60, the switches 602 and 604 included in the first switch are two double-electrode single-throw switches. When a control signal Ca output from the display control circuit 20 is in the H level, the switches 602 and 604 are turned on. When the control signal Ca is in the L level, the switches 602 and 604 are turned off. The switch 602 of the two switches is disposed between the common feed line 31 and a video feed line 161, and the switch 604 is disposed between the common feed line 32 and a video feed line 162. In addition, the resistor R1 and the variable resistor R2 are serially connected between the common feed lines 31 and 32. The resistor R1 and variable resistor R2 constitute an offset voltage generating circuit according to the invention.

When a control signal Cb output from the display control circuit 20 is in the H level, a switch 606 included in the second switch is turned on, and when the control signal Cb is in the L level, the switch 606 is turned off. The switch 606 is disposed between a connection point (output terminal) of a resistor R1 and a variable resistor R2 and the video feed line 162.

In addition, the capacitance device 608 is interposed between the video feed lines 161 and 162.

As shown in FIG. 5, with respect to the control signals Ca and Cb, in the near-front period Ha of the horizontal scan period H, the control signal Ca is in the H level, and the control signal Cb is in the L level. In the near-rear period Hb, the control signal Ca is in the L level, and the control signal Cb is in the H level.

Therefore, in the period Ha, since the switches 602 and 604 are turned on and the switch 606 is turned off, the video feed line 161 is the voltage ComH of the common feed line 31, and the video feed line 162 is the voltage ComL of the common feed line 32. The capacitance device 608 is charged with the voltage ComH−ComL.

Next, in the period Hb, since the switches 602 and 604 are turned off and the switch 606 is turned on, the video feed line 162 has a voltage ComL+A that is obtained by increasing the voltage ComL of the common feed line 32 by a voltage A (offset voltage) that is a voltage divided from a voltage ComH−ComL by the resistors R1 and R2. In addition, the video feed line 161 has a voltage ComH+A that is obtained by increasing the voltage ComL+A of the video feed line 162 by a charged voltage ComH−ComL of the capacitance device 608.

Herein, in order to offset the fall in the voltage of the TFT 116 due to the field-through phenomenon from the voltage A, the resistance value of the variable resistor R2 is adjusted so that the voltage A is equal to ΔVp.

Among the devices included in the video voltage supplying circuit 60, since the switches 602, 604, and 606 are implemented as peripheral circuit embedded types, these switches are preferably constructed with thin film transistors similarly to the TFT 116 included in the pixel 110.

Next, a configuration of the data line driving circuit that applies to the data lines 114 voltages according to the designation of the written polarity and the designation of a white display or black display is described.

The shift register 150 outputs sampling signals S1 to 5240 according to a start pulse Dx and a clock signal Clx supplied from the display control circuit 20. More specifically, as shown in FIG. 4, the shift register 150 sequentially shifts the start pulse Dx indicating the start of the horizontal scan period H according to the clock signal Clx synchronizing with a dot clock signal and reduces the pulse width thereof down to one half of the frequency of the clock signal Clx, so that sampling signals S1, S2, S3, S4, . . . , and S240 corresponding to the columns are output.

On the other hand, an EX-OR circuit 170 outputs an logical exclusive OR signal of the image signal Xd and the polarity designating signal Frp.

The switches 152 are disposed in correspondence with the columns. A switch 152 corresponding to an arbitrary column is turned on when a sampling signal corresponding to the column is in the H level so that the logical exclusive OR signal of the EX-OR circuit 170 is sampled.

The first latch circuits 154 are disposed in correspondence with the columns so as to latch the logical exclusive OR signal sampled by the switches 152.

The switches 156 are disposed in correspondence with the columns. Each switch 156 is turned on when the latch signal Lp is in the H level. Herein, the latch signal Lp is a pulse output after the scan signal to the selected scan line is changed from the H level to the L level in the horizontal scan period H.

The second latch circuits 158 are disposed in correspondence with the columns to acquire and re-latch the logical exclusive OR signal latched by the first latch circuit 154 by the turning-on of the switch 156.

The double-throw switches 160 are disposed in correspondence with the columns. A switch 160 corresponding to an arbitrary column selects the video feed line 161 when the logical exclusive OR signal re-latched by the second latch circuit 158 corresponding to the column is in the L level and the video feed line 162 when the logical exclusive OR signal is in the H level. Therefore, the voltage supplied to the selected video feed line is applied to the data line 114.

Operations of the data line driving circuit having the configuration are described with reference to FIG. 4.

As shown in the figure, when the image signals Xd corresponding to pixels of the i-th row and the first, second, third, . . . , and 240-th columns are applied from an upper apparatus in a horizontal scan period H, the display control circuit 20 applies the start pulse Dx and the clock signal Clx to the shift register 150 so that the sampling signals S1, S2, S3, . . . , and S240 are sequentially in the H level in synchronization with the image signal Xd.

As a result, a logical exclusive OR signal of the image signal Xd and the polarity designating signal Frp corresponding to the pixel of the i-th row and the first column is latched in the first latch circuit 154 of the first column. Similarly, logical exclusive OR signals of the image signals Xd and the polarity designating signals Frp corresponding to the pixel of the i-th row and the second, third, . . . , and 240-th columns are sequentially latched in the first latch circuits 154 of the second, third, . . . , and 240-th columns.

If the latch signal Lp is in the H level over the time interval from the current horizontal scan period to the next horizontal scan period, all the switches 156 are turned on, so that the logical exclusive OR signals latched in the first latch circuits 154 of the first to 240-th columns are re-latched in the second latch circuits 158 of the first to 240-th columns.

At this time, if the re-latched logical exclusive OR signals are in the L level, each of the switches 160 of the first to 240-th columns selects the video feed line 161. Herein, in a case where the negative polarity writing is designated (the polarity designating signal Frp is in the H level) in the horizontal scan period H in which the image signal Xd for the pixel of the i-th row is supplied, the logical exclusive OR signal is in the L level at the time when a white display is designated to the pixel of the i-th row.

In addition, if the re-latched logical exclusive OR signals are in the H level, each of the switches 160 of the first to 240-th columns selects the video feed line 162. Herein, in the case where the negative polarity writing is designated in the horizontal scan period H in which the image signal Xd for the pixel of the i-th row is supplied, the logical exclusive OR signal is in the H level at the time when black display is designated to the pixel of the i-th row.

Although the timing when the logical exclusive OR signals are latched in the second latch circuits 158 of the first to 240-th columns are delayed by the horizontal scan period H from the timing of logic calculation of the EX-OR circuit 170, the voltage of the common electrode 108 is defined as a signal Frp-d that is obtained by delaying the polarity designating signal Frp by the horizontal scan period H. Therefore, in the case where the negative polarity writing is designated by the polarity designating signal Frp in the horizontal scan period H in which the image signal Xd of the pixel of the i-th row is supplied, when the logical exclusive OR signals are re-latched in the second latch circuits 158 of the first to 240-th columns, the common electrode 108 has the voltage ComH corresponding to the negative polarity writing.

After the logical exclusive OR signals are re-latched in the second latch circuits 158 of the first to 240-th columns, the control signal Ca is changed from the H level to the L level, and the control signal Cb is changed from the L level to the H level. As a result, the video feed line 161 has the voltage ComH+A, and the video feed line 162 has the voltage ComL+A.

Accordingly, in a case where the scan signal Yi is in the H level so that the TFT 116 is turned on, if the white display is designated to the pixel of the i-th row to which the negative polarity writing is designated, a voltage ComH+A, that is obtained by increasing the voltage so as to offset the fall in the voltage of the voltage ΔVp in the TFT 116 due to the field-through phenomenon, is applied to the data line 114. If the black display is designated, a voltage ComL+A that is obtained by increasing the voltage by the fall in the voltage due to the field-through phenomenon. Therefore, even in the case where the scan signal Yi is changed from the H level to the L level so that the voltage falls by the voltage ΔVp due to the field-through phenomenon at the time when the TFT 116 is turned off, the pixel electrode 118 has the voltage ComH in the white display and the voltage ComL in the black display.

In addition, herein, the case where the negative polarity writing is designated (the polarity designating signal Frp is in the H level) in the horizontal scan period H in which the image signal Xd for the pixel of the i-th row is supplied is exemplified for the description. On the contrary, in the case where the positive polarity writing is designated (the polarity designating signal Frp is in the L level), the logical exclusive OR signal is in the L level at the time when the black display is designated to the pixel of the i-th row. The logical exclusive OR signal is in the H level at the time when the white display is designated to the pixel of the i-th row.

In addition, in a case where the positive polarity writing is designated by the polarity designating signal Frp in the horizontal scan period H in which the image signal Xd of the pixel of the i-th row is supplied, when the logical exclusive OR signals are re-latched in the second latch circuits 158 of the first to 240-th columns, the common electrode 108 has the voltage ComL corresponding to the positive polarity writing.

Similarly to the negative polarity writing, after the logical exclusive OR signals are re-latched in the second latch circuits 158 of the first to 240-th columns, the video feed line 161 has the voltage ComH+A, and the video feed line 162 has the voltage ComL+A.

Accordingly, in the case where the scan signal Yi is in the H level so that the TFT 116 is turned on, if the black display is designated to the pixel of the i-th row to which the positive polarity writing is designated, the voltage ComH+A is applied to the data line 114. If the white display is designated, the voltage ComL+A is applied to the data line 114. Therefore, even in the case where the scan signal Yi changes from the H level to the L level so that the voltage falls due to the field-through phenomenon at the time when the TFT 116 is turned off, the pixel electrode 118 has the voltage ComH in the black display and the voltage ComL in the white display.

FIG. 6A shows a change in the voltage Pix of the pixel electrode 118 of the pixel of the i-th row to which the black (ON) display is designated with respect to the i-th row scan signal Yi and the common signal Com in the electro-optical apparatus 10 according to the embodiment.

As shown in the figure, when the scan signal Yi is in the H level, if the positive polarity writing is designated, the voltage Pix of the pixel electrode 118 is the video voltage ComH+A. At the time when the scan signal Yi is in the L level, the voltage Pix is the voltage ComH by the fall of the voltage ΔVp in the TFT 116 due to the field-through phenomenon. When the scan signal Yi is in the H level, if the negative polarity writing is designated, the voltage Pix is the video voltage ComL+A. At the time when the scan signal Yi is in the L level, the voltage Pix falls by the voltage ΔVp to be the voltage ComL.

Herein, if the scan signal Yi is in the L level, the TFT 116 is in the off state. Therefore, the voltage Pix of the pixel electrode 118 is changed so that the voltage ComH−ComL is maintained according to a change in the common signal Com.

According to the electro-optical apparatus 10 of the embodiment, if the voltage sustained in the liquid crystal capacitance 120, that is, the voltage difference between the pixel electrode 118 and the common electrode 108 that is indicated by hatching falls by the voltage ΔVp due to the field-through phenomenon, the voltage can have substantially the same value by the positive polarity writing and the negative polarity writing and the burn-in or flicker can be prevented.

In addition, in the embodiment, since the two-valued voltages for the video voltages, that is, the low level voltage ComL+A and the high level voltage ComH+A are obtained by offsetting the two-valued voltages of the common voltages, that is, the low level voltage ComL and the high level voltage ComH by the voltage A toward the high level, even though the common voltages are changed for some reason, the two-valued voltages for the video voltages can be the voltages that are obtained by offsetting the change in the voltage due to the field-through phenomenon from the change in the common voltages. Therefore, in the embodiment, even through the voltage of the common electrode changes, the effective value of the voltage sustained in the liquid crystal capacitance do not vary with the positive polarity and the negative polarity.

In addition, FIG. 6B is a view showing a change in the voltage Pix of the pixel electrode 118 in the case where the common voltages ComH and ComL are used as the video voltages without consideration of a decrease in the voltage ΔVp due to the field-through phenomenon. In the figure, due to the fall in voltage due to the field-through phenomenon, the effective value of the voltage of the liquid crystal capacitance 120 in the negative polarity writing is higher than that in the positive polarity writing, and a DC component is applied.

In addition, in the configuration of the embodiment, the logical exclusive OR signal of the image signal Xd and the polarity designating signal Frp is calculated by the EX-OR circuit 170, and any one of the voltage ComL+A of the video feed line 161 and the voltage ComH+A of the video feed line 162 is selected by the switch 160 according to the logical exclusive OR signal, and the selected voltage is applied to the data line 114.

As a similar configuration, for example, as shown in FIG. 8, switches 191 to 194 are turned on and off according to a signal Frp-d that is obtained by delaying the polarity designating signal Frp from the voltage ComL+A of the video feed line 161 and the voltage ComH+A of the video feed line 162, so that the white voltage corresponding to the white display and the black voltage corresponding to the black display are obtained. In addition, if the black display or the white display is designated by a latched image signal X, the black voltage or the white voltage is selected by a switch 195, respectively, so as to be applied to the data line 114.

However, in the configuration shown in FIG. 8, since the switches 191 to 194 are disposed between the feed lines 161 and 162 having high load, there is a need to reduce the ON resistance. Therefore, the sizes of transistors constituting these switches need to be enlarged. In addition, all the switches 191 to 194 may be turned ON and OFF according to logic levels of the signal Frp-d and the inverted signal thereof, noise may be superposed on the white voltage and the black voltage.

However, in the embodiment, since the output of the EX-OR circuit 170 is a gate signal, the load is lowered. Therefore, the EX-OR circuit 170 can be implemented with a small size. In addition, almost no influence from the noise can be superposed.

In addition, in the embodiment, since the TFT 116 is of the n channel type, the direction of change in the voltage ΔVp of the pixel electrode 118 due to the field-through phenomenon becomes the falling direction. On the contrary, if the TFT 116 is of a p channel type, the direction of change becomes the rising direction.

Therefore, in a configuration where the TFT 116 is of the p channel type, the video voltage supplying circuit 60 may be constructed so that the video feed line 161 has a voltage ComL−A and the video feed line 162 has a voltage ComH−A. More specifically, a switch 606 may be disposed between a point of connection of the resistor R1 and the variable resistor R2 and the video feed line 161, and with respect to the voltage A (offset voltage), the resistance value of the variable resistor R2 may be adjusted so as to offset the increasing voltage of the voltage ΔVp of the p channel type TFT 116 due to the field-through phenomenon.

### Example of Electronic Apparatuses

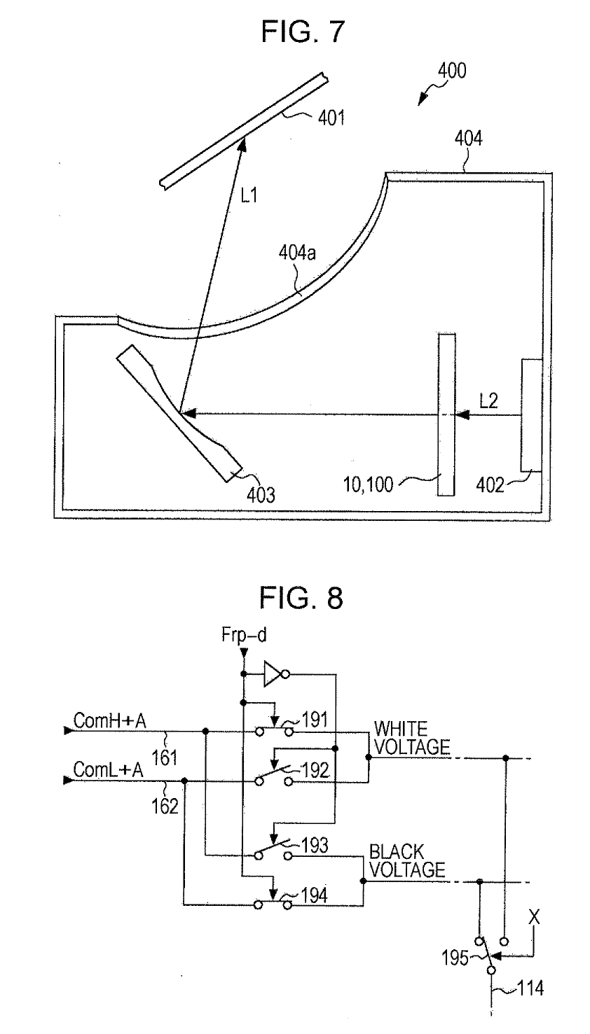

Now, an electronic apparatus employing the electro-optical apparatus 10 according to the aforementioned embodiment is described. FIG. 7 is a view showing a configuration of the head-up display 400 using the electro-optical apparatus 10 according to the embodiment.

The electro-optical apparatus 10 is disposed between a backlight 402 and a concave mirror 403 so as to emit a display light L1 on a to-be-displayed object (for example, the windshield of a vehicle) 401. The display light L1 emitted from the electro-optical apparatus 10 is generated by incidence of a light L2 from the backlight 402 to the electro-optical apparatus 10. In addition, the display light L1 is reflected by the concave mirror 403 toward the to-be-displayed object 401 to be emitted to the to-be-displayed object 401.

In addition, the electro-optical apparatus 10, the backlight 402, and the concave mirror 403 are accommodated inside the case 404 having a window 404a that transmits the display light L1. The head-up display 400 for the vehicle is used to display information need to drive the vehicle (for example, speed information, engine rotation number information, information on various alarms, road information, road guiding information, information on obstacles such as a human and an object. Since it is important that the information display can be clearly viewed by a driver, the use of two-valued display is suitable. Since the electro-optical apparatus 10 according to the embodiment is a display apparatus for performing two-valued display, the electro-optical apparatus 10 is very suitable for the head-up display 400.

Various apparatuses as well as the head-up display shown in FIG. 7 can be used as the electronic apparatus that employs the electro-optical apparatus 10.

What is claimed is:

1. A video voltage supplying circuit of an electro-optical apparatus which includes:
a plurality of scan lines;
a plurality of data lines;
pixels that are disposed corresponding to intersections of the scan lines and the data lines, each pixel including a transistor having a gate electrode that is connected to the scan line to be applied with a select voltage, a source electrode that is connected to the data line, and a drain electrode that is connected to a pixel electrode and a liquid crystal capacitance where liquid crystal is interposed between the pixel electrode and a common electrode;
a common electrode driving circuit that supplies high and low level common voltages to the common electrode through a common feed line, wherein when positive polarity writing for enabling the pixel electrode to be in a voltage level higher than a voltage of the common electrode is performed on the pixel corresponding to the scan line, the low level common voltage is supplied, and when negative polarity writing for enabling the pixel electrode to be in a voltage level lower than the voltage of the common electrode is performed on the pixel corresponding to the scan line, the high level common voltage is supplied;
a data line driving circuit that is connected to a video feed line supplied with high and low level video voltages, wherein when the select voltage is applied to the scan line, the data line driving circuit supplies one of the high and low level video voltages to the pixel corresponding to the one scan line through the data line according to designation of the white display or the black display and designation of the written polarity; and
a video voltage supplying circuit that is connected to the common feed line to supply the high and low level common voltages to the video feed line,
wherein the video voltage supplying circuit comprises an offset voltage generating circuit generating an offset voltage to supply as the video voltage a voltage that is obtained by offsetting the common voltage by only a predetermined voltage in a predetermined direction by using the offset voltage.

2. The video voltage supplying circuit according to claim 1,
wherein the video voltage supplying circuit connects the high level common feed line and the low level common feed line to the high level video feed line and the low level video feed line, respectively, so that voltages of the high level video feed line and the low level video feed line are equal to voltages of the high level common feed line and the low level common feed line, and
wherein, next, the video voltage supplying circuit applies the offset voltage output from the offset voltage generating circuit to the video feed lines, so that a voltage that is obtained by offsetting the common voltage by only a predetermined voltage in a predetermined direction is applied as the video voltage.

3. The video voltage supplying circuit according to claim 1,
wherein the video voltage supplying circuit includes:
a first switch that connects the high level common feed line and the low level common feed line to the high level video feed line and the low level video feed line, respectively;
an offset voltage generating circuit that is connected between the high level common feed line and the low level common feed line;
a second switch that connects the offset voltage output from the offset voltage generating circuit to the low level video feed line; and
a capacitance device of which two terminals are connected to the high level video feed line and the low level video feed line,
wherein, when the first switch is turned on, the first switch connects the common feed lines to the video feed lines, so that voltages of the high level video feed line and the low level video feed line are equal to the voltages of the high level common feed line and the low level common feed line, respectively,
wherein, when the first switch is turned off, the second switch is turned on to supply the offset voltage to the low level video feed line, and
wherein the capacitance device supplies the offset voltage through the capacitance device to the high level video feed line, so that a voltage that is obtained by offsetting the common voltages by only a predetermined voltage in a predetermined direction is applied as the video voltage.

4. The video voltage supplying circuit according to claim 1, wherein the transistor, the first switch, and the second switch are constructed with thin film transistors that are formed on the same glass substrate.

5. An electro-optical apparatus which includes:
a plurality of scan lines;
a plurality of data lines;
pixels that are disposed corresponding to intersections of the scan lines and the data lines, each pixel including a transistor having a gate electrode that is connected to the scan line to be applied with a select voltage, a source electrode that is connected to the data line, and a drain electrode that is connected to a pixel electrode and a liquid crystal capacitance where liquid crystal is interposed between the pixel electrode and a common electrode;
a common electrode driving circuit that supplies high and low level common voltages to the common electrode through a common feed line, wherein when positive polarity writing for enabling the pixel electrode to be in a voltage level higher than a voltage of the common electrode is performed on the pixel corresponding to the scan line, the low level common voltage is supplied, and when negative polarity writing for enabling the pixel electrode to be in a voltage level lower than the voltage of the common electrode is performed on the pixel corresponding to the scan line, the high level common voltage is supplied;
a data line driving circuit that is connected to a video feed line supplied with high and low level video voltages, wherein when the select voltage is applied to the scan line, the data line driving circuit supplies one of the high and low level video voltages to the pixel corresponding to the one scan line through the data line according to designation of the white display or the black display and designation of the written polarity; and
a video voltage supplying circuit that is connected to the common feed line to supply the high and low level common voltages to the video feed line,
wherein the video voltage supplying circuit comprises an offset voltage generating circuit generating an offset voltage to supply as the video voltage a voltage that is obtained by offsetting the common voltage by only a predetermined voltage in a predetermined direction by using the offset voltage.

6. The electro-optical apparatus according to claim 5, wherein the data line driving circuit applies one of the video voltages to the data line according to a logical exclusive OR signal of an image signal designating white display or black display and a polarity designating signal designating written polarity.

7. An electronic apparatus having the electro-optical apparatus according to claim 5.
